(19) United States
(12) Patent Application Publication
(10) Pub. No.: US 2013/0147589 A1
(43) Pub. Date: Jun. 13, 2013

(54) Fast Transient Mitigator Circuit Integrated Within A Vacuum Cast Transformer

(71) Applicant: ABB TECHNOLOGY AG, Affolternstrasse 44 (CH)

(72) Inventors: Charles W. Johnson, Wytheville, VA (US); Robert C. Ballard, Wytheville, VA (US); David S. Vinson, Radford, VA (US); Marek Florkowski, Krakow (PL); Wojciech Piasecki, Krakow (PL)

(73) Assignee: ABB TECHNOLOGY AG, Affolternstrasse 44 (CH)

(21) Appl. No.: 13/709,119

(22) Filed: Dec. 10, 2012

(30) Foreign Application Priority Data
Dec. 13, 2011 (EP) 11193227.3

(51) Int. Cl. H01F 27/02; H01F 41/00

(52) U.S. Cl. CPC H01F 27/022; H01F 41/005
USPC 336/96; 29/606

(57) ABSTRACT

A transformer (10) includes a ferromagnetic core (14); winding structure (12) mounted on the core; electrical terminals (40, 40′) connected to the winding structure; a fast transient mitigator circuit (52) including an impedance circuit serially connected between one of the terminals and the winding structure, and a capacitor connected from the one terminal to external ground. The mitigator circuit is constructed and arranged to reduce a frequency spectrum and magnitude of fast transients. An encasement (16), of an insulating resin, commonly encapsulates the core, the winding structure and at least the impedance circuit of the mitigator circuit.

### FIELD

The invention relates to transformers and, more particularly, to a fast transient mitigator circuit integrated into a cast transformer.

### BACKGROUND

Fast transients, due to system switching or environmental impact can cause damage to the transformer windings and reduce the life thereof. Conventional “snubber” circuits include a resistor and a capacitor that are connected externally to the transformer terminal. The resistor is always in the circuit and adds additional losses to the transformer. Since the resistor and capacitor components are external to the transformer winding structure, they are required by ANSI standards to be disconnected during impulse tests and while the transformer winding structure is tested with fast transients associated with impulse voltage.

Thus, there is a need to integrate a fast transient mitigator circuit into a transformer.

### SUMMARY

An object of the invention is to fulfill the need referred to above. In accordance with the principles of an embodiment, this objective is achieved by providing a transformer having a ferromagnetic core; winding structure mounted on the core; electrical terminals connected to the winding structure; a fast transient mitigator circuit including an impedance circuit serially connected between one of the terminals and the winding structure, and a capacitor connected from the one terminal to external ground. The mitigator circuit is constructed and arranged to reduce the frequency spectrum and magnitude of fast transients. An encasement, of an insulating resin, commonly encapsulates the core, the winding structure, and at least the impedance circuit of the mitigator circuit.

In accordance with another aspect of an embodiment, a method provides a fast transient mitigator circuit integrated within a transformer. The method provides a ferromagnetic core. A winding structure is mounted on the core. Electrical terminals are connected to the winding structure. A fast transient mitigator circuit is provided and includes an impedance circuit serially connected between one of the terminals and the winding structure, and a capacitor connected from the one terminal to external ground, to reduce the frequency spectrum and magnitude of fast transients. The core, the winding structure, and at least the impedance circuit are encapsulated in a one insulating resin.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The features, aspects, and advantages of the present invention will become better understood with regard to the following description, appended claims, and accompanying drawings where:

FIG. 1 is a front perspective view of a transformer embodied in accordance with the present invention, with an outer encasement of the transformer shown in phantom;

FIG. 2 is a circuit diagram of the transformer of FIG. 1; and

FIG. 3 is an enlarged front view of the fast transient mitigator circuit in accordance with another embodiment.

### DETAILED DESCRIPTION OF EXAMPLE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

The present invention is directed to a dry-type transformer 10 to provide power to residences and small businesses. As such, the transformer 10 is a step-down transformer that receives an input voltage and steps it down to a lower, output voltage. The transformer preferably has a rating from about 16 kVA to 500 kVA, with an input voltage in a range from 2,400 to 34,500 Volts and an output voltage in a range from 120 to 600 Volts. The transformer 10 generally includes a winding structure preferably including a plurality of winding modules 12. The winding modules 12 are mounted to a ferromagnetic core 14 and all of which are disposed inside an encasement 16 formed from one or more resins, as will be described more fully below. The core 14 and the winding modules 12 mounted thereto are cast into the resin(s) so as to be encapsulated within the encasement 16.

The encasement 16 includes a generally annular body 18 joined to a base 20. The body 18 has a center passage 21 extending there-through. A pair of frusto-conical high voltage bushings 22, 22′ extends upwardly and outwardly from a top portion of the body 18. A low voltage terminal pad (not shown) is joined to a front surface of the body 18, above the center passage 21.

The core 14 is composed of a ferromagnetic material, such as iron or steel, and has an inner opening and a closed periphery. The core 14 may have a rectangular frame shape or an annular shape (as shown), such as a toroid. The core 14 may be comprised of a strip of steel (such as grain-oriented silicon steel), which is wound on a mandrel into a coil. Alternately, the core 14 may be formed from a stack of plates, which may be rectangular or annular and of the same or varying width or circumference, as the case may be.

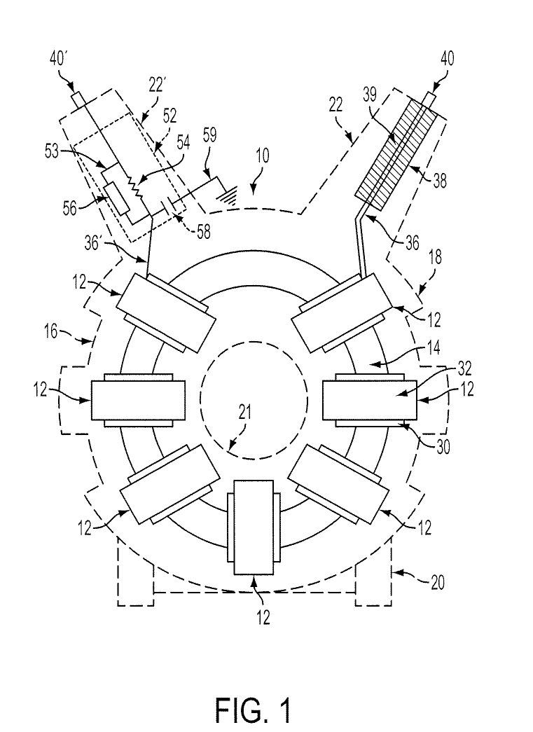

As shown in FIG. 1, a plurality of winding modules 12 is mounted to the core 14 in a spaced-apart fashion. Although seven winding modules 12 are shown in FIG. 1, it should be appreciated that a different number of winding modules 12 may be provided without departing from the scope of the present invention. Each winding module 12 includes a low voltage winding segment 30 mounted concentrically inside a high voltage winding segment 32. The low voltage winding segment 30 and the high voltage winding segment 32 may each be cylindrical in shape. Each of the low and high voltage winding segments 30, 32 may be formed using a layer winding technique, wherein a conductor is wound in one or more concentric conductor layers connected in series. The low voltage winding segment 30 may have a longer axial length than the high voltage winding segment 32, as is shown. The conductor may be foil strip(s), sheet(s), or wire with a rectangular or circular cross-section. The conductor may be composed of copper or aluminum. A layer of insulation material is disposed between each pair of conductor layers.

The winding modules 12 may be wound directly on the core 14. Alternately, the winding modules 12 may be formed on a mandrel and then mounted to the core 14 if the core 14 is formed with a gap or is formed from several pieces that are secured together after the winding modules 12 are mounted thereto.

The low voltage winding segments 30 of the winding modules 12 are electrically connected together (either in series or in parallel) by conductors to form a low voltage winding. Similarly, the high voltage winding segments 32 are electrically connected together (either in series or in parallel) by conductors to form a high voltage winding.

Ends of the high voltage winding formed by the segments 32 are connected to leads 36, 36′, which extend through the body 18 and are ultimately secured to terminals 40, 40′, respectively, which are fixed to the ends of the high voltage bushings 22. A helical coil 38 may be disposed inside one of the high voltage bushings 22. The coil 38 is comprised of conductive wire that is helically wound to form a cylinder having a central passage 39. The conductive wire may or may not be encased in an insulating covering. The outer end of the conductive wire is secured to a terminal 40. The inner end of the conductive wire is folded inwardly so as to be disposed inside the central passage of the coil 38. The lead 36 extends through the central passage 39 of the coil 38. In this manner, the coil 38 is disposed around and spaced from the lead 36. The coil 38 controls the electrical fields that may be generated when current passes through the lead 36 and thereby reduce the dielectric stress on the resin material of the high voltage bushing 22.

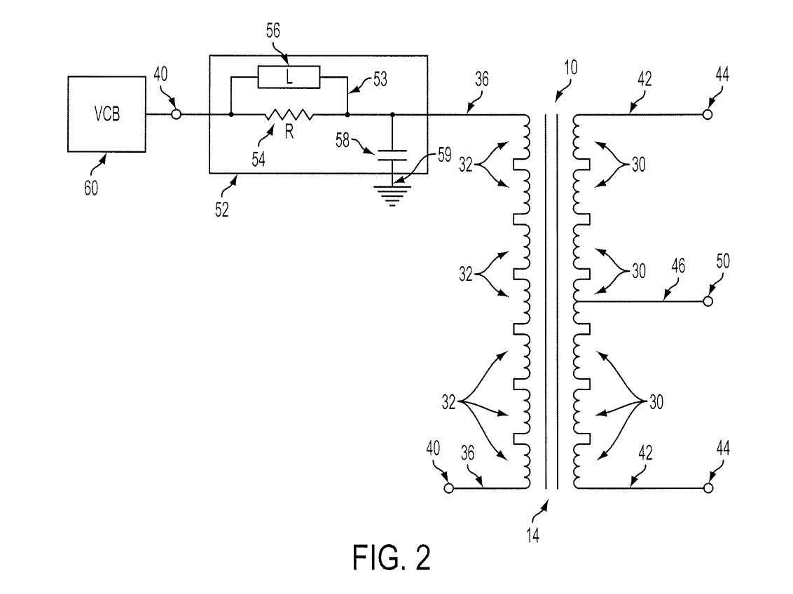

As schematically shown in FIG. 2, ends of the low voltage winding formed by the segments 30 are connected to leads 42, which extend through the body 18 and are secured to terminals 44 that extend from the low voltage terminal pad (not shown). A center tap on the low voltage winding is connected by a lead 46 to a neutral terminal 50 that extends from the terminal pad. The neutral terminal 50 is connected to ground. The terminals 44 and 50 provide connections for a single-phase, three-wire distribution system. The voltage between the terminals 44 may be 240 Volts, while the voltage between one of the terminals 44 and the terminal 50 is 120 Volts.

Returning to FIG. 1, a fast transient mitigator circuit 52 is provided integrally within the body 18 of the encasement 16, preferably within the high voltage bushing 22′. As best shown in FIG. 2, the fast transient mitigator circuit 52 includes an impedance circuit 53 comprising a parallel combination of a resistor 54 and an inductor 56. The impedance circuit 53 is serially connected between the coil terminal 40′ and a high voltage winding segment 32 via lead 36′. In addition, the mitigator circuit 52 includes a capacitor 58 connected from the coil terminal 40′ through the encasement 16 to external ground, via lead 59. When the transformer 10 is connected to a vacuum circuit breaker 60 (FIG. 2) and operating at power frequency, the parallel impedance circuit 53 will operate as a direct short, bypassing the resistor 54 and eliminating the associated resistive losses. At fast transient (high or extra high) frequencies, the inductor 56 functions as an open circuit, allowing the resistor 54 to function and, in conjunction with the capacitor 58, reduces the frequency spectrum (or reduce the rate of rise dU/dt) and magnitude of the fast transient thereby reducing the overvoltage stress on the transformer winding modules 12 and thus minimize damage to insulation systems such as insulating resins.

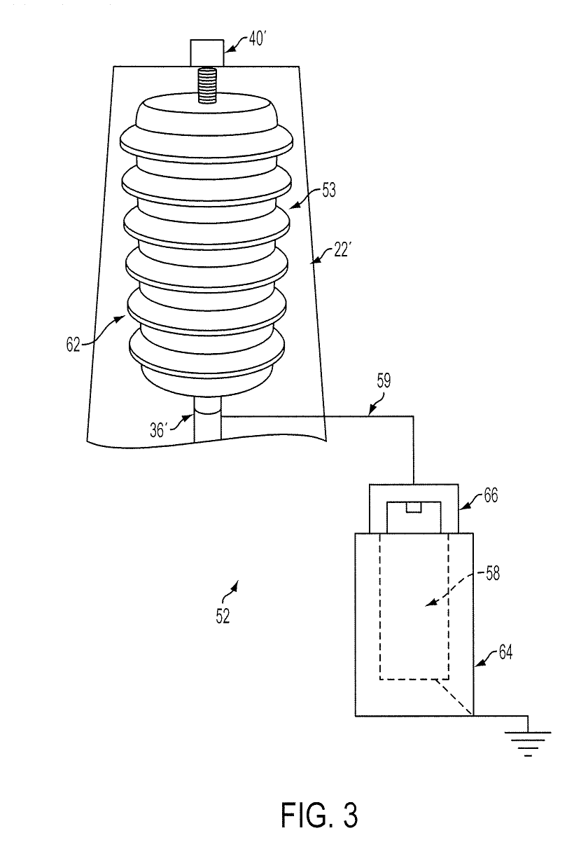

As shown in FIG. 3, the inductor 56 and the resistor 54 of the impedance circuit 53 may be cast into one or more resins so as to be encapsulated within an encasement structure 62 that is separate from the encasement 16. The encasement 62 may be formed from the same resins and in the same manner as the encasement 16. The capacitor 58 may be mounted inside a housing 64 and may be connected to the impedance circuit 53 by a conductive bus bar 66, which is also electrically connected to the terminal 40′. As in FIG. 2, the entire mitigator circuit 52 (encased resistor 54 and inductor 56, and capacitor 58) can then be cast into the high voltage bushing 22′ when the encasement 16 is formed, or as shown FIG. 3, the impedance circuit 53 can be encapsulated in the high voltage bushing 22′, with the capacitor 58 (and housing 64) mounted outside of the high voltage bushing 22′ of the encasement 16. Mounting the capacitor 58 outside of the encasement 16 reduces dielectric stress inside the epoxy resin encasement 16.

The resistor 54 has a resistance in a range from about 20-150 Ohms to provide wave termination. The inductor 56 is non-saturable with the working current and has an impedance value that is selected such that the voltage drop at 50 Hz is small in order not to generate heat in the resistor 54. The impedance of the inductor 56 is greater than the resistance of the resistor 54 at frequencies greater than 10 kHZ. The capacitance of the capacitor 58 is relatively small, having a value of about 5-20 nanofarads (nF), more particularly about 10 nF.

The interconnected winding modules 12 mounted to the core 14, together with the leads 36, 42, 46, mitigator circuit 52 and the coil 38 form an electrical assembly that is cast into one or more insulating resins that is/are cured to form the encasement 16. The encasement 16 may be formed from a single insulating resin, which may be butyl rubber or an epoxy resin. In one embodiment, the resin is a cycloaliphatic epoxy resin, still more particularly a hydrophobic cycloaliphatic epoxy resin composition. Such an epoxy resin composition may comprise a cycloaliphatic epoxy resin, a curing agent, an accelerator and, optionally, filler, such as silanised quartz powder, fused silica powder, or silanised fused silica powder. The curing agent may be an anhydride, such as a linear aliphatic polymeric anhydride, or a cyclic carboxylic anhydride. The accelerator may be an amine, an acidic catalyst (such as stannous octoate), an imidazole, or a quaternary ammonium hydroxide or halide.

The encasement 16 may be formed from the resin composition in an automatic pressure gelation (APG) process. In accordance with APG process, the resin composition (in liquid form) is degassed and preheated to a temperature above 40 C, while under vacuum. The electrical assembly is placed in a cavity of a mold heated to an elevated curing temperature of the resin. The leads 36, 36′, 42, 46 and 59 extend out of the cavity through openings so as to protrude from the encasement 16 after the casting process. The degassed and preheated resin composition is then introduced under slight pressure into the cavity containing the electrical assembly. Inside the cavity, the resin composition quickly starts to gel. The resin composition in the cavity, however, remains in contact with pressurized resin being introduced from outside the cavity. In this manner, the shrinkage of the gelled resin composition in the cavity is compensated for by subsequent further addition of degassed and preheated resin composition entering the cavity under pressure. After the resin composition cures to a solid, the solid encasement 16 with the electrical assembly molded therein is removed from the mold cavity. The encasement 16 is then allowed to fully cure.

It should be appreciated that in lieu of being formed pursuant to an APG process, the encasement 16 may be formed using an open casting process or a vacuum casting process. In an open casting process, the resin composition is simply poured into an open mold containing the electrical assembly and then heated to the elevated curing temperature of the resin. In vacuum casting, the electrical assembly is disposed in a mold enclosed in a vacuum chamber or casing. The resin composition is mixed under vacuum and introduced into the mold in the vacuum chamber, which is also under vacuum. The mold is heated to the elevated curing temperature of the resin. After the resin composition is dispensed into the mold, the pressure in the vacuum chamber is raised to atmospheric pressure.

By integrating the mitigator circuit 52 directly into the encasement 16, all fast transients including those associated with impulse voltages can be controlled. Therefore, electrical stresses on air gaps are reduced and the air clearances may be reduced. The impact of dielectric stresses on solid insulation associated with switching surges and transient recovery voltages are decreased, allowing for a reduction in the insulation thickness.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A transformer comprising:
a ferromagnetic core;
winding structure mounted on the core;
electrical terminals connected to the winding structure;
a fast transient mitigator circuit comprising an impedance circuit serially connected between one of the terminals and the winding structure, and a capacitor connected from the one terminal to external ground, the mitigator circuit being constructed and arranged to reduce a frequency spectrum and magnitude of fast transients; and
an encasement, comprised of an insulating resin, commonly encapsulating the core, the winding structure, and at least the impedance circuit of the mitigator circuit.

2. The transformer of claim 1, wherein the encasement includes a body having a central passage extending there-through and a pair of high voltage bushings extending outwardly from the body; wherein a pair of terminals is provided with each terminal extending from an associated high voltage bushings and being connected to the winding structure.

3. The transformer of claim 2, wherein the impedance circuit is encapsulated in one of the high voltage bushings.

4. The transformer of claim 2, wherein the mitigator circuit is encapsulated in one of the high voltage bushings.

5. The transformer of claim 2, wherein the impedance circuit comprises a parallel combination of a resistor and an inductor, wherein, when the transformer is operating at power frequency, the resistor is constructed and arranged to be bypassed and, at fast transient frequencies, the inductor is constructed and arranged to function as an open circuit, allowing the resistor to function in conjunction with the capacitor.

6. The transformer of claim 5, wherein the resistor and inductor are encapsulated within an encasement structure separate from the encasement.

7. The transformer of claim 1, wherein the winding structure comprises a plurality of coil assemblies mounted to the core, each of the coil assemblies comprising a low voltage coil and a high voltage coil, the low voltage coils being connected together and the high voltage coils being connected together, the high voltage coils being connected to the terminals.

8. The transformer of claim 2, wherein the body is substantially annular in shape and each of the high voltage bushings is substantially frusto-conical in shape.

9. The transformer of claim 3, further comprising a helical coil disposed in the other high voltage bushing, and leads connecting the winding structure to the other terminal, the leads extending through the helical coil.

10. A method of providing a fast transient mitigator circuit integrated within a transformer, the method comprising the steps of:
providing a ferromagnetic core;
mounting winding structure on the core;
providing electrical terminals connected to the winding structure;
providing a fast transient mitigator circuit comprising an impedance circuit serially connected between one of the terminals and the winding structure, and a capacitor connected from the one terminal to external ground, to reduce a frequency spectrum and magnitude of fast transients, and
encapsulating, in one insulating resin, the core, the winding structure, and at least the impedance circuit of the mitigator circuit.

11. The method of claim 10, wherein the step of encapsulating includes defining an encasement including a body having a central passage extending there-through and a pair of high voltage bushings extending outwardly from the body.

12. The method of claim 11 wherein a pair of terminals is provided with each terminal extending from an associated high voltage bushings and connected to the winding structure.

13. The method of claim 11, wherein the step of encapsulating includes encapsulating the mitigator circuit in one of the high voltage bushings.

14. The method of claim 11, wherein the step of encapsulating includes encapsulating the impedance circuit in one of the high voltage bushings.

15. The method of claim 14, wherein the impedance circuit comprises a parallel combination of a resistor and an inductor, and the method further comprises prior to the encapsulating step:
initially encapsulating the resistor and inductor in insulating resin.

16. The method of claim 10, wherein step of mounting the winding structure includes mounting a plurality of low voltage coils and a plurality of high voltage coils on the core, and connecting the low voltage coils together and connecting the high voltage coils together, with the high voltage coils being connected to the terminals.

17. The method of claim 11, wherein the body is of substantially annular in shape and each of the high voltage bushings is of substantially frusto-conical in shape.

18. The method of claim 12, further comprising:
encapsulating a helical coil in the other high voltage bushing, with leads connecting the winding structure to the other terminal, the leads extending through the helical coil.

19. The method of claim 10, wherein the step of encapsulating occurs in a vacuum casting process.
